(19) United States
(12) Patent Application Publication
(10) Pub. No.: US 2026/0028237 A1
(43) Pub. Date: Jan. 29, 2026

(54) METHODS OF PREPARING DRY GEL ZEOLITES WITH HYDROGEL DRYING

(71) Applicant: Saudi Arabian Oil Company, Dhahran (SA)

(72) Inventors: Lianhui Ding, Dhahran (SA); Mohammad F. Aljishi, Dhahran (SA); Faisal Alotaibi, Dhahran (SA)

(21) Appl. No.: 18/782,709

(22) Filed: Jul. 24, 2024

(51) Int. Cl. C01B 39/48; C01B 39/40

(52) U.S. Cl. CPC C01B 39/48; C01B 39/40; C01P 2002/04; C01P 2004/64; C01P 2006/12; C01P 2006/14; C01P 2006/16

(57) ABSTRACT

This disclosure relates to methods of preparing a dry gel zeolite including drying the zeolite hydrogel under reduced pressure to form a dry gel zeolite.

### TECHNICAL FIELD

This document relates to methods of preparing a dry gel zeolite including drying the zeolite hydrogel under reduced pressure to form a dry gel zeolite.

### BACKGROUND

Zeolites, such as zeolite beta and Zeolite Socony Mobil-5 (ZSM-5), are widely used in petroleum processing for various applications, such as catalytic cracking, catalytic reforming, and hydrocracking. For many such applications, poor diffusion efficiency of bulky molecules through zeolite pores limit their utility. Thus, smaller zeolite particle sizes are preferred, as smaller particle size correlates to higher external surface area and shorter diffusion paths of molecules through the zeolite pores.

Thus, the development of methods that result in smaller, more uniform zeolite particles are needed.

### SUMMARY

The disclosure relates to methods of preparing a dry gel zeolite including combining zeolite precursor materials; stirring the zeolite precursor materials to form a zeolite hydrogel; and drying the zeolite hydrogel at a pressure of about 0.001 mbar to about 250 mbar and a temperature of about 20° C. to about 100° C. to form the dry gel zeolite.

In some embodiments, the method further includes grinding the dry gel zeolite.

In some embodiments, the method further includes crystallizing the dry gel zeolite.

In some embodiments, the method further includes isolating the dry gel zeolite.

In some embodiments, the method further includes washing the dry gel zeolite with a solvent.

In some embodiments, the method further includes heating the dry gel zeolite.

In some embodiments, the method further includes calcinating the dry gel zeolite.

The disclosure further relates to methods of preparing a dry gel zeolite including: combining zeolite precursor materials; stirring the zeolite precursor materials to form a zeolite hydrogel; drying the zeolite hydrogel at a pressure of about 0.001 mbar to about 250 mbar and a temperature of about 20° C. to about 100° C. to form the dry gel zeolite; grinding the dry gel zeolite; crystallizing the dry gel zeolite; isolating the dry gel zeolite; washing the dry gel zeolite; heating the dry gel zeolite; and calcinating the dry gel zeolite.

In some embodiments, the zeolite precursor materials include an aluminum source, a silica source, and a template source.

In some embodiments, the aluminum source is selected from NaAlO₂, aluminum isopropoxide (AIP), Al₂ (SO₄)₃, Al(NO₃)₃, AlCl₃, aluminum powder, Al(OH)₃, and Al₂O₃.

In some embodiments, the silicon source is selected from tetraethylorthosilicate (TEOS), colloidal silica, Na₂SiO₃, and fumed silica.

In some embodiments, the template source is selected from tetrapropylammonium hydroxide (TPAOH) and tetraethylammonium hydroxide (TEAOH).

In some embodiments, the aluminum source is selected from NaAlO₂, aluminum isopropoxide (AIP), Al₂(SO₄)₃, Al(NO₃)₃, AlCl₃, aluminum powder, Al(OH)₃, and Al₂O₃; the silica source is selected from tetraethylorthosilicate (TEOS), colloidal silica, Na₂SiO₃, and fumed silica; and the template source is selected from tetrapropylammonium hydroxide (TPAOH) and tetraethylammonium hydroxide (TEAOH).

In some embodiments, the dry gel zeolite is ZSM-5 or zeolite beta.

In some embodiments, drying the zeolite hydrogel is performed at a pressure of about 0.005 mbar to about 15 mbar.

In some embodiments, drying the zeolite hydrogel is performed at a pressure of about 0.01 mbar to about 10 mbar.

In some embodiments, drying the zeolite hydrogel is performed at a temperature of about 30° C. to about 90° C.

In some embodiments, drying the zeolite hydrogel is performed at a temperature of about 40° C. to about 80° C.

In some embodiments, drying the zeolite hydrogel is performed at a temperature of about 60° C.

In some embodiments, drying the zeolite hydrogel is performed for about 12 h or less.

In some embodiments, drying the zeolite hydrogel is performed for about 2 h to about 10 h.

In some embodiments, drying the zeolite hydrogel is performed for about 4 h to about 8 h.

In some embodiments, drying the zeolite hydrogel is performed at a pressure of about 0.005 mbar to about 15 mbar, a temperature of about 30° C. to about 90° C. for about 2 h to about 10 h.

In some embodiments, drying the zeolite hydrogel is performed at a pressure of about 0.01 mbar to about 10 mbar, a temperature of about 40° C. to about 80° C. for about 4 h to about 8 h.

In some embodiments, crystallizing the dry gel zeolite is performed in an autoclave.

In some embodiments, crystallizing the dry gel zeolite is performed at a temperature of about 100° C. to about 250° C. for about 12 h to about 5 d.

In some embodiments, heating the dry gel zeolite includes heating the dry gel zeolite to a temperature of about 80° C. to about 150° C. for about 6 h to about 36 h.

In some embodiments, calcinating the dry gel zeolite includes heating the dry gel zeolite to a temperature of about 450° C. to about 650° C. for about 1 h to about 8 h.

In some embodiments, the dry gel zeolite has a relative crystallinity of 90% or greater.

In some embodiments, drying the zeolite hydrogel takes less time than a method of preparing a dry gel zeolite where drying the zeolite hydrogel is not performed at a pressure of about 0.001 mbar to about 25 mbar and a temperature of about 20° C. to about 100° C. to form the dry gel zeolite.

In some embodiments, the method uses about 80% less template source than a method of preparing a dry gel zeolite where drying the zeolite hydrogel is not performed at a pressure of about 0.001 mbar to about 25 mbar and a temperature of about 20° C. to about 100° C. to form the dry gel zeolite.

### DESCRIPTION OF DRAWINGS

FIG. 1 is a diagram of an exemplary hydrogel drying device. In this example, zeolite hydrogel is added to a two-neck flask equipped with a condenser and vacuum pump, and heated in an oil bath. The evaporated water vapor is condensed and collected in a bottle.

### DETAILED DESCRIPTION

The present disclosure relates to methods of preparing a dry gel zeolite. In some embodiments, the method includes combining zeolite precursor materials; stirring the zeolite precursor materials to form a zeolite hydrogel; and drying the zeolite hydrogel at a pressure of about 0.001 mbar to about 250 mbar and a temperature of about 20° C. to about 100° C. to form the dry gel zeolite. During the drying step of the disclosed method, the generated steam contacts the dry-gel and promotes the amorphous silica-alumina crystallize to form zeolite. Conventional methods of zeolite synthesis perform the drying step at ambient pressure. Compared to such methods, the disclosed methods may require shorter crystallization time and less energy, and result in higher product yield, higher zeolite crystallinity, and reduced emission of waste solvents.

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

The term “about” as used herein can allow for a degree of variability in a value or range, for example, within ±10% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In some embodiments, the method further includes grinding the dry gel zeolite.

In some embodiments, the method further includes crystallizing the dry gel zeolite.

In some embodiments, the method further includes isolating the dry gel zeolite.

In some embodiments, the method further includes washing the dry gel zeolite with solvent.

In some embodiments, the solvent is water. In some embodiments, the solvent is deionized water.

In some embodiments, the method further includes heating the dry gel zeolite.

In some embodiments, the method further includes calcinating the dry gel zeolite.

The present disclosure further relates to methods of preparing a dry gel zeolite including: combining zeolite precursor materials; stirring the zeolite precursor materials to form a zeolite hydrogel; drying the zeolite hydrogel at a pressure of about 0.001 mbar to about 250 mbar and a temperature of about 20° C. to about 100° C. to form the dry gel zeolite; crystallizing the dry gel zeolite; heating the dry gel zeolite; and calcinating the dry gel zeolite.

The present disclosure further relates to methods of preparing a dry gel zeolite including: combining zeolite precursor materials; stirring the zeolite precursor materials to form a zeolite hydrogel; drying the zeolite hydrogel at a pressure of about 0.001 mbar to about 250 mbar and a temperature of about 20° C. to about 100° C. to form the dry gel zeolite; grinding the dry gel zeolite; crystallizing the dry gel zeolite; isolating the dry gel zeolite; washing the dry gel zeolite with a solvent; heating the dry gel zeolite; and calcinating the dry gel zeolite.

In some embodiments, the zeolite precursor materials include an aluminum source. In some embodiments, the zeolite precursor materials include a silica source. In some embodiments, the zeolite precursor materials include a template source.

In some embodiments, the zeolite precursor materials include an aluminum source and a silica source. In some embodiments, the zeolite precursor materials include an aluminum source and a template source. In some embodiments, the zeolite precursor materials include a silica source, and a template source.

In some embodiments, the zeolite precursor materials include an aluminum source, a silica source, and a template source.

In some embodiments, the aluminum source is selected from NaAlO₂, aluminum isopropoxide (AIP), Al₂(SO₄)₃, Al(NO₃)₃, AlCl₃, aluminum powder, Al(OH)₃, and Al₂O₃. In some embodiments, the aluminum source is selected from Al₂(SO₄)₃ and Al(NO₃)₃. In some embodiments, the aluminum source is NaAlO₂. In some embodiments, the aluminum source is aluminum isopropoxide (AIP). In some embodiments, the aluminum source is Al₂(SO₄)₃. In some embodiments, the aluminum source is Al(NO₃)₃. In some embodiments, the aluminum source is AlCl₃. In some embodiments, the aluminum source is aluminum powder. In some embodiments, the aluminum source is Al(OH)₃. In some embodiments, the aluminum source is Al₂O₃.

In some embodiments, the silicon source is selected from tetraethylorthosilicate (TEOS), colloidal silica, Na₂SiO₃, and fumed silica. In some embodiments, the silicon source is tetraethylorthosilicate (TEOS). In some embodiments, the silicon source is colloidal silica. In some embodiments, the silicon source is Na₂SiO₃. In some embodiments, the silicon source is fumed silica.

In some embodiments, the template source is selected from tetrapropylammonium hydroxide (TPAOH) and tetraethylammonium hydroxide (TEAOH). In some embodiments, the template source is tetrapropylammonium hydroxide (TPAOH). In some embodiments, the template source is tetraethylammonium hydroxide (TEAOH).

In some embodiments, the zeolite precursor materials include an aluminum source, a silica source, and a template source, where:
the aluminum source is selected from NaAlO₂, aluminum isopropoxide (AIP), Al₂(SO₄)₃, Al(NO₃)₃, AlCl₃, aluminum powder, Al(OH)₃, and Al₂O₃;
the silica source is selected from tetraethylorthosilicate (TEOS), colloidal silica, Na₂SiO₃, and fumed silica; and
the template source is selected from tetrapropylammonium hydroxide (TPAOH) and tetraethylammonium hydroxide (TEAOH).

In some embodiments, the zeolite precursor materials include an aluminum source, a silica source, and a template source, where:
the aluminum source is selected from Al₂(SO₄)₃ and Al(NO₃)₃;
the silica source is fumed silica; and
the template source is selected from tetrapropylammonium hydroxide (TPAOH) and tetraethylammonium hydroxide (TEAOH).

In some embodiments, the aluminum source is Al₂(SO₄)₃, the silica source is fumed silica, and the template source is tetrapropylammonium hydroxide.

In some embodiments, the aluminum source is Al₂(SO₄)₃, the silica source is fumed silica, and tetraethylammonium hydroxide (TEAOH).

In some embodiments, the aluminum source is Al(NO₃)₃, the silica source is fumed silica, and the template source is tetrapropylammonium hydroxide.

In some embodiments, the aluminum source is Al(NO₃)₃, the silica source is fumed silica, and tetraethylammonium hydroxide (TEAOH).

In some embodiments, the dry gel zeolite is ZSM-5 or zeolite beta. In some embodiments, the dry gel zeolite is ZSM-5. In some embodiments, the dry gel zeolite is zeolite beta.

In some embodiments, drying the zeolite hydrogel is performed at a pressure of about 0.001 mbar to about 250 mbar. In some embodiments, drying the zeolite hydrogel is performed at a pressure of about 0.001 mbar to about 25 mbar. In some embodiments, drying the zeolite hydrogel is performed at a pressure of about 0.005 mbar to about 15 mbar. In some embodiments, where drying the zeolite hydrogel is performed at a pressure of about 0.01 mbar to about 10 mbar.

In some embodiments, drying the zeolite hydrogel is performed at a pressure of about 0.005 mbar to about 25 mbar. In some embodiments, drying the zeolite hydrogel is performed at a pressure of about 0.01 mbar to about 25 mbar. In some embodiments, drying the zeolite hydrogel is performed at a pressure of about 0.05 mbar to about 25 mbar. In some embodiments, drying the zeolite hydrogel is performed at a pressure of about 0.1 mbar to about 25 mbar. In some embodiments, drying the zeolite hydrogel is performed at a pressure of about 1 mbar to about 25 mbar. In some embodiments, drying the zeolite hydrogel is performed at a pressure of about 5 mbar to about 25 mbar. In some embodiments, drying the zeolite hydrogel is performed at a pressure of about 10 mbar to about 25 mbar. In some embodiments, drying the zeolite hydrogel is performed at a pressure of about 15 mbar to about 25 mbar. In some embodiments, drying the zeolite hydrogel is performed at a pressure of about 20 mbar to about 25 mbar.

In some embodiments, drying the zeolite hydrogel is performed at a pressure of about 0.001 mbar to about 20 mbar. In some embodiments, drying the zeolite hydrogel is performed at a pressure of about 0.001 mbar to about 15 mbar. In some embodiments, drying the zeolite hydrogel is performed at a pressure of about 0.001 mbar to about 10 mbar. In some embodiments, drying the zeolite hydrogel is performed at a pressure of about 0.001 mbar to about 5 mbar. In some embodiments, drying the zeolite hydrogel is performed at a pressure of about 0.001 mbar to about 1 mbar. In some embodiments, drying the zeolite hydrogel is performed at a pressure of about 0.001 mbar to about 0.1 mbar. In some embodiments, drying the zeolite hydrogel is performed at a pressure of about 0.001 mbar to about 0.05 mbar. In some embodiments, drying the zeolite hydrogel is performed at a pressure of about 0.001 mbar to about 0.01 mbar. In some embodiments, drying the zeolite hydrogel is performed at a pressure of about 0.001 mbar to about 0.005 mbar.

In some embodiments, drying the zeolite hydrogel is performed at a pressure of about 0.001 mbar. In some embodiments, drying the zeolite hydrogel is performed at a pressure of about 0.005 mbar.

In some embodiments, drying the zeolite hydrogel is performed at a pressure of about 0.01 mbar. In some embodiments, drying the zeolite hydrogel is performed at a pressure of about 0.05 mbar. In some embodiments, drying the zeolite hydrogel is performed at a pressure of about 0.1 mbar. In some embodiments, drying the zeolite hydrogel is performed at a pressure of about 1 mbar. In some embodiments, drying the zeolite hydrogel is performed at a pressure of about 5 mbar. In some embodiments, drying the zeolite hydrogel is performed at a pressure of about 10 mbar. In some embodiments, drying the zeolite hydrogel is performed at a pressure of about 15 mbar. In some embodiments, drying the zeolite hydrogel is performed at a pressure of about 20 mbar. In some embodiments, drying the zeolite hydrogel is performed at a pressure of about 25 mbar.

In some embodiments, drying the zeolite hydrogel is performed at a temperature of about 20° C. to about 100° C. In some embodiments, drying the zeolite hydrogel is performed at a temperature of about 30° C. to about 90° C. In some embodiments, drying the zeolite hydrogel is performed at a temperature of about 40° C. to about 80° C. In some embodiments, drying the zeolite hydrogel is performed at a temperature of about 50° C. to about 70° C.

In some embodiments, drying the zeolite hydrogel is performed at a temperature of about 30° C. to about 100° C. In some embodiments, drying the zeolite hydrogel is performed at a temperature of about 40° C. to about 100° C. In some embodiments, drying the zeolite hydrogel is performed at a temperature of about 50° C. to about 100° C. In some embodiments, drying the zeolite hydrogel is performed at a temperature of about 60° C. to about 100° C. In some embodiments, drying the zeolite hydrogel is performed at a temperature of about 70° C. to about 100° C. In some embodiments, drying the zeolite hydrogel is performed at a temperature of about 80° C. to about 100° C. In some embodiments, drying the zeolite hydrogel is performed at a temperature of about 90° C. to about 100° C.

In some embodiments, drying the zeolite hydrogel is performed at a temperature of about 20° C. to about 90° C. In some embodiments, drying the zeolite hydrogel is performed at a temperature of about 20° C. to about 80° C. In some embodiments, drying the zeolite hydrogel is performed at a temperature of about 20° C. to about 70° C. In some embodiments, drying the zeolite hydrogel is performed at a temperature of about 20° C. to about 60° C. In some embodiments, drying the zeolite hydrogel is performed at a temperature of about 20° C. to about 50° C. In some embodiments, drying the zeolite hydrogel is performed at a temperature of about 20° C. to about 40° C. In some embodiments, drying the zeolite hydrogel is performed at a temperature of about 20° C. to about 30° C.

In some embodiments, drying the zeolite hydrogel is performed at a temperature of about 20° C. In some embodiments, drying the zeolite hydrogel is performed at a temperature of about 30° C. In some embodiments, drying the zeolite hydrogel is performed at a temperature of about 40° C. In some embodiments, drying the zeolite hydrogel is performed at a temperature of about 50° C. In some embodiments, drying the zeolite hydrogel is performed at a temperature of about 60° C. In some embodiments, drying the zeolite hydrogel is performed at a temperature of about 70° C. In some embodiments, drying the zeolite hydrogel is performed at a temperature of about 80° C. In some embodiments, drying the zeolite hydrogel is performed at a temperature of about 90° C. In some embodiments, drying the zeolite hydrogel is performed at a temperature of about 100° C.

In some embodiments, drying the zeolite hydrogel is performed for about 12 h or less. In some embodiments, drying the zeolite hydrogel is performed for about 10 h or less. In some embodiments, drying the zeolite hydrogel is performed for about 8 h or less. In some embodiments, drying the zeolite hydrogel is performed for about 6 h or less. In some embodiments, drying the zeolite hydrogel is performed for about 4 h or less.

In some embodiments, drying the zeolite hydrogel is performed for about 2 h to about 10 h. In some embodiments, drying the zeolite hydrogel is performed for about 4 h to about 8 h.

In some embodiments, drying the zeolite hydrogel is performed for about 4 h to about 10 h. In some embodiments, drying the zeolite hydrogel is performed for about 6 h to about 10 h. In some embodiments, drying the zeolite hydrogel is performed for about 8 h to about 10 h.

In some embodiments, drying the zeolite hydrogel is performed for about 2 h to about 8 h. In some embodiments, drying the zeolite hydrogel is performed for about 2 h to about 6 h. In some embodiments, drying the zeolite hydrogel is performed for about 2 h to about 5 h.

In some embodiments, drying the zeolite hydrogel is performed for about 2 h. In some embodiments, drying the zeolite hydrogel is performed for about 3 h. In some embodiments, drying the zeolite hydrogel is performed for about 4 h. In some embodiments, drying the zeolite hydrogel is performed for about 5 h. In some embodiments, drying the zeolite hydrogel is performed for about 6 h. In some embodiments, drying the zeolite hydrogel is performed for about 7 h. In some embodiments, drying the zeolite hydrogel is performed for about 8 h. In some embodiments, drying the zeolite hydrogel is performed for about 9 h. In some embodiments, drying the zeolite hydrogel is performed for about 10 h.

In some embodiments, drying the zeolite hydrogel is performed at a pressure of about 0.005 mbar to about 15 mbar, a temperature of about 30° C. to about 90° C. for about 2 h to about 10 h.

In some embodiments, drying the zeolite hydrogel is performed at a pressure of about 0.01 mbar to about 10 mbar, a temperature of about 40° C. to about 80° C. for about 4 h to about 8 h.

In some embodiments, the dry gel zeolite is performed in an autoclave.

In some embodiments, crystallizing the dry gel zeolite is performed at a temperature of about 100° C. to about 250° C. In some embodiments, crystallizing the dry gel zeolite is performed at a temperature of about 140° C. to about 200° C. In some embodiments, crystallizing the dry gel zeolite is performed at a temperature of about 110° C. to about 170° C.

In some embodiments, crystallizing the dry gel zeolite is performed at a temperature of about 100° C. In some embodiments, crystallizing the dry gel zeolite is performed at a temperature of about 110° C. In some embodiments, crystallizing the dry gel zeolite is performed at a temperature of about 140° C. In some embodiments, crystallizing the dry gel zeolite is performed at a temperature of about 170° C. In some embodiments, crystallizing the dry gel zeolite is performed at a temperature of about 200° C. In some embodiments, crystallizing the dry gel zeolite is performed at a temperature of about 220° C. In some embodiments, crystallizing the dry gel zeolite is performed at a temperature of about 250° C.

In some embodiments, crystallizing the dry gel zeolite is performed for about 12 h to about 5 d. In some embodiments, crystallizing the dry gel zeolite is performed for about 2 d to about 4 d.

In some embodiments, crystallizing the dry gel zeolite is performed for about 12 h. In some embodiments, crystallizing the dry gel zeolite is performed for about 24 h. In some embodiments, crystallizing the dry gel zeolite is performed for about 1 d. In some embodiments, crystallizing the dry gel zeolite is performed for about 2 d. In some embodiments, crystallizing the dry gel zeolite is performed for about 3 d. In some embodiments, crystallizing the dry gel zeolite is performed for about 4 d. In some embodiments, crystallizing the dry gel zeolite is performed for about 5 d.

In some embodiments, crystallizing the dry gel zeolite is performed at a temperature of about 100° C. to about 250° C. for about 12 h to about 5 d. In some embodiments, crystallizing the dry gel zeolite is performed at a temperature of about 140° C. to about 200° C. for about 2 d to about 4 d. In some embodiments, crystallizing the dry gel zeolite is performed at a temperature of about 110° C. to about 170° C. for about 2 d to about 4 d. In some embodiments, crystallizing the dry gel zeolite is performed at a temperature of about 140° C. for about 3 d. In some embodiments, crystallizing the dry gel zeolite is performed at a temperature of about 170° C. for about 3 d.

In some embodiments, heating the dry gel zeolite includes heating the dry gel zeolite to a temperature of about 80° C. to about 150° C. In some embodiments, heating the dry gel zeolite includes heating the dry gel zeolite to a temperature of about 90° C. to about 140° C. In some embodiments, heating the dry gel zeolite includes heating the dry gel zeolite to a temperature of about 100° C. to about 130° C. In some embodiments, heating the dry gel zeolite includes heating the dry gel zeolite to a temperature of about 110° C. to about 120° C.

In some embodiments, heating the dry gel zeolite includes heating the dry gel zeolite to a temperature of about 80° C. In some embodiments, heating the dry gel zeolite includes heating the dry gel zeolite to a temperature of about 90° C. In some embodiments, heating the dry gel zeolite includes heating the dry gel zeolite to a temperature of about 100° C. In some embodiments, heating the dry gel zeolite includes heating the dry gel zeolite to a temperature of about 110° C. In some embodiments, heating the dry gel zeolite includes heating the dry gel zeolite to a temperature of about 120° C. In some embodiments, heating the dry gel zeolite includes heating the dry gel zeolite to a temperature of about 130° C. In some embodiments, heating the dry gel zeolite includes heating the dry gel zeolite to a temperature of about 140° C. In some embodiments, heating the dry gel zeolite includes heating the dry gel zeolite to a temperature of about 150° C.

In some embodiments, heating the dry gel zeolite includes heating the dry gel zeolite for about 6 h to about 36 h. In some embodiments, heating the dry gel zeolite includes heating the dry gel zeolite for about 8 h to about 24 h. In some embodiments, heating the dry gel zeolite includes heating the dry gel zeolite for about 10 h to about 20 h.

In some embodiments, heating the dry gel zeolite includes heating the dry gel zeolite for about 6 h. In some embodiments, heating the dry gel zeolite includes heating the dry gel zeolite for about 8 h. In some embodiments, heating the dry gel zeolite includes heating the dry gel zeolite for about 10 h. In some embodiments, heating the dry gel zeolite includes heating the dry gel zeolite for about 12 h. In some embodiments, heating the dry gel zeolite includes heating the dry gel zeolite for about 14 h. In some embodiments, heating the dry gel zeolite includes heating the dry gel zeolite for about 16 h. In some embodiments, heating the dry gel zeolite includes heating the dry gel zeolite for about 18 h. In some embodiments, heating the dry gel zeolite includes heating the dry gel zeolite for about 20 h. In some embodiments, heating the dry gel zeolite includes heating the dry gel zeolite for about 24 h. In some embodiments, heating the dry gel zeolite includes heating the dry gel zeolite for about 30 h. In some embodiments, heating the dry gel zeolite includes heating the dry gel zeolite for about 36 h.

In some embodiments, heating the dry gel zeolite includes heating the dry gel zeolite to a temperature of about 80° C. to about 150° C. for about 6 h to about 36 h. In some embodiments, heating the dry gel zeolite includes heating the dry gel zeolite to a temperature of about 100° C. to about 130° C. for about 8 h to about 24 h. In some embodiments, heating the dry gel zeolite includes heating the dry gel zeolite to a temperature of about 110° C. for about 8 h to about 24 h. In some embodiments, heating the dry gel zeolite includes heating the dry gel zeolite to a temperature of about 120° C. for about 8 h to about 24 h.

In some embodiments, calcinating the dry gel zeolite includes heating the dry gel zeolite to a temperature of about 450° C. to about 650° C. In some embodiments, calcinating the dry gel zeolite includes heating the dry gel zeolite to a temperature of about 475° C. to about 625° C. In some embodiments, calcinating the dry gel zeolite includes heating the dry gel zeolite to a temperature of about 500° C. to about 600° C. In some embodiments, calcinating the dry gel zeolite includes heating the dry gel zeolite to a temperature of about 525° C. to about 575° C.

In some embodiments, calcinating the dry gel zeolite includes heating the dry gel zeolite to a temperature of about 450° C. In some embodiments, calcinating the dry gel zeolite includes heating the dry gel zeolite to a temperature of about 475° C. In some embodiments, calcinating the dry gel zeolite includes heating the dry gel zeolite to a temperature of about 500° C. In some embodiments, calcinating the dry gel zeolite includes heating the dry gel zeolite to a temperature of about 525° C. In some embodiments, calcinating the dry gel zeolite includes heating the dry gel zeolite to a temperature of about 550° C. In some embodiments, calcinating the dry gel zeolite includes heating the dry gel zeolite to a temperature of about 575° C. In some embodiments, calcinating the dry gel zeolite includes heating the dry gel zeolite to a temperature of about 600° C. In some embodiments, calcinating the dry gel zeolite includes heating the dry gel zeolite to a temperature of about 625° C. In some embodiments, calcinating the dry gel zeolite includes heating the dry gel zeolite to a temperature of about 650° C.

In some embodiments, calcinating the dry gel zeolite includes heating the dry gel zeolite for about 1 h to about 8 h. In some embodiments, calcinating the dry gel zeolite includes heating the dry gel zeolite for about 2 h to about 6 h. In some embodiments, calcinating the dry gel zeolite includes heating the dry gel zeolite for about 3 h to about 5 h.

In some embodiments, calcinating the dry gel zeolite includes heating the dry gel zeolite for about 1 h. In some embodiments, calcinating the dry gel zeolite includes heating the dry gel zeolite for about 2 h. In some embodiments, calcinating the dry gel zeolite includes heating the dry gel zeolite for about 3 h. In some embodiments, calcinating the dry gel zeolite includes heating the dry gel zeolite for about 4 h. In some embodiments, calcinating the dry gel zeolite includes heating the dry gel zeolite for about 5 h. In some embodiments, calcinating the dry gel zeolite includes heating the dry gel zeolite for about 6 h. In some embodiments, calcinating the dry gel zeolite includes heating the dry gel zeolite for about 7 h. In some embodiments, calcinating the dry gel zeolite includes heating the dry gel zeolite for about 8 h.

In some embodiments, calcinating the dry gel zeolite includes heating the dry gel zeolite to a temperature of about 450° C. to about 650° C. for about 1 h to about 8 h. In some embodiments, calcinating the dry gel zeolite includes heating the dry gel zeolite to a temperature of about 500° C. to about 600° C. for about 2 h to about 6 h. In some embodiments, calcinating the dry gel zeolite includes heating the dry gel zeolite to a temperature of about 525° C. to about 570° C. for about 3 h to about 5 h.

In some embodiments, calcinating the dry gel zeolite includes heating the dry gel zeolite to a temperature of about 550° C. for about 4 h.

In some embodiments, drying the zeolite hydrogel takes less time than a method of preparing a dry gel zeolite where drying the zeolite hydrogel is not performed at a pressure of about 0.001 mbar to about 25 mbar and a temperature of about 20° C. to about 100° C. to form the dry gel zeolite.

In some embodiments, the method uses less template source than a method of preparing a dry gel zeolite where drying the zeolite hydrogel is not performed at a pressure of about 0.001 mbar to about 25 mbar and a temperature of about 20° C. to about 100° C. to form the dry gel zeolite. In some embodiments, the method uses about 25% less template source than a method of preparing a dry gel zeolite where drying the zeolite hydrogel is not performed at a pressure of about 0.001 mbar to about 25 mbar and a temperature of about 20° C. to about 100° C. to form the dry gel zeolite. In some embodiments, the method uses about 50% less template source than a method of preparing a dry gel zeolite where drying the zeolite hydrogel is not performed at a pressure of about 0.001 mbar to about 25 mbar and a temperature of about 20° C. to about 100° C. to form the dry gel zeolite. In some embodiments, the method uses about 75% less template source than a method of preparing a dry gel zeolite where drying the zeolite hydrogel is not performed at a pressure of about 0.001 mbar to about 25 mbar and a temperature of about 20° C. to about 100° C. to form the dry gel zeolite. In some embodiments, the method uses about 80% less template source than a method of preparing a dry gel zeolite where drying the zeolite hydrogel is not performed at a pressure of about 0.001 mbar to about 25 mbar and a temperature of about 20° C. to about 100° C. to form the dry gel zeolite. In some embodiments, the method uses about 85% less template source than a method of preparing a dry gel zeolite where drying the zeolite hydrogel is not performed at a pressure of about 0.001 mbar to about 25 mbar and a temperature of about 20° C. to about 100° C. to form the dry gel zeolite.

In some embodiments, the dry gel zeolite has a relative crystallinity greater than the relative crystallinity of a dry gel zeolite prepared using a method where drying the zeolite hydrogel is not performed at a pressure of about 0.001 mbar to about 25 mbar and a temperature of about 20° C. to about 100° C. to form the dry gel zeolite.

In some embodiments, the dry gel zeolite has a relative crystallinity of about 75% or greater. In some embodiments, the dry gel zeolite has a relative crystallinity of about 80% or greater. In some embodiments, the dry gel zeolite has a relative crystallinity of about 85% or greater. In some embodiments, the dry gel zeolite has a relative crystallinity of about 90% or greater. In some embodiments, the dry gel zeolite has a relative crystallinity of about 95% or greater. In some embodiments, the dry gel zeolite has a relative crystallinity of about 98% or greater. In some embodiments, the dry gel zeolite has a relative crystallinity of about 99% or greater. In some embodiments, the dry gel zeolite has a relative crystallinity of about 99.9% or greater.

In some embodiments, the dry gel zeolite has a relative crystallinity of about 75% to about 99.9%. In some embodiments, the dry gel zeolite has a relative crystallinity of about 80% to about 99%. In some embodiments, the dry gel zeolite has a relative crystallinity of about 85% to about 98%. In some embodiments, the dry gel zeolite has a relative crystallinity of about 90% to about 95%.

In some embodiments, the dry gel zeolite has a relative crystallinity of about 75%. In some embodiments, the dry gel zeolite has a relative crystallinity of about 80%. In some embodiments, the dry gel zeolite has a relative crystallinity of about 85%. In some embodiments, the dry gel zeolite has a relative crystallinity of about 90%. In some embodiments, the dry gel zeolite has a relative crystallinity of about 95%. In some embodiments, the dry gel zeolite has a relative crystallinity of about 98%. In some embodiments, the dry gel zeolite has a relative crystallinity of about 99%. In some embodiments, the dry gel zeolite has a relative crystallinity of about 99.9%. In some embodiments, the dry gel zeolite has a relative crystallinity of about 100%.

In some embodiments, the crystallinity of the dry gel zeolite is measured with x-ray diffraction (XRD) analysis.

In some embodiments, the dry gel zeolite has an average particle size of about 1 nm to about 150 nm. In some embodiments, the dry gel zeolite has an average particle size of about 5 nm to about 125 nm. In some embodiments, the dry gel zeolite has an average particle size of about 10 nm to about 100 nm. In some embodiments, the dry gel zeolite has an average particle size of about 25 nm to about 75 nm. In some embodiments, the dry gel zeolite has an average particle size of about 40 nm to about 60 nm.

In some embodiments, the dry gel zeolite has an average particle size of about 1 nm. In some embodiments, the dry gel zeolite has an average particle size of about 5 nm. In some embodiments, the dry gel zeolite has an average particle size of about 10 nm. In some embodiments, the dry gel zeolite has an average particle size of about 20 nm. In some embodiments, the dry gel zeolite has an average particle size of about 25 nm. In some embodiments, the dry gel zeolite has an average particle size of about 30 nm. In some embodiments, the dry gel zeolite has an average particle size of about 40 nm. In some embodiments, the dry gel zeolite has an average particle size of about 50 nm. In some embodiments, the dry gel zeolite has an average particle size of about 60 nm. In some embodiments, the dry gel zeolite has an average particle size of about 70 nm. In some embodiments, the dry gel zeolite has an average particle size of about 75 nm. In some embodiments, the dry gel zeolite has an average particle size of about 80 nm. In some embodiments, the dry gel zeolite has an average particle size of about 90 nm. In some embodiments, the dry gel zeolite has an average particle size of about 100 nm. In some embodiments, the dry gel zeolite has an average particle size of about 110 nm. In some embodiments, the dry gel zeolite has an average particle size of about 125 nm. In some embodiments, the dry gel zeolite has an average particle size of about 150 nm.

In some embodiments, the dry gel zeolite has an average surface area of about 400 m²/g to about 800 m²/g. In some embodiments, the dry gel zeolite has an average surface area of about 450 m²/g to about 750 m²/g. In some embodiments, the dry gel zeolite has an average surface area of about 500 m²/g to about 700 m²/g. In some embodiments, the dry gel zeolite has an average surface area of about 550 m²/g to about 650 m²/g.

In some embodiments, the dry gel zeolite has an average surface area of about 400 m²/g. In some embodiments, the dry gel zeolite has an average surface area of about 450 m²/g. In some embodiments, the dry gel zeolite has an average surface area of about 500 m²/g. In some embodiments, the dry gel zeolite has an average surface area of about 550 m²/g. In some embodiments, the dry gel zeolite has an average surface area of about 600 m²/g. In some embodiments, the dry gel zeolite has an average surface area of about 650 m²/g. In some embodiments, the dry gel zeolite has an average surface area of about 700 m²/g. In some embodiments, the dry gel zeolite has an average surface area of about 750 m²/g. In some embodiments, the dry gel zeolite has an average surface area of about 800 m²/g.

In some embodiments, the dry gel zeolite has an average pore volume of about 0.1 mL/g to about 5.0 mL/g. In some embodiments, the dry gel zeolite has an average pore volume of about 0.25 mL/g to about 2.5 mL/g. In some embodiments, the dry gel zeolite has an average pore volume of about 0.3 mL/g to about 1.2 mL/g. In some embodiments, the dry gel zeolite has an average pore volume of about 0.4 mL/g to about 1.1 mL/g. In some embodiments, the dry gel zeolite has an average pore volume of about 0.5 mL/g to about 1.0 mL/g. In some embodiments, the dry gel zeolite has an average pore volume of about 0.6 mL/g to about 0.8 mL/g.

In some embodiments, the dry gel zeolite has an average pore volume of about 0.1 mL/g. In some embodiments, the dry gel zeolite has an average pore volume of about 0.25 mL/g. In some embodiments, the dry gel zeolite has an average pore volume of about 0.3 mL/g. In some embodiments, the dry gel zeolite has an average pore volume of about 0.4 mL/g. In some embodiments, the dry gel zeolite has an average pore volume of about 0.5 mL/g. In some embodiments, the dry gel zeolite has an average pore volume of about 0.6 mL/g. In some embodiments, the dry gel zeolite has an average pore volume of about 0.7 mL/g. In some embodiments, the dry gel zeolite has an average pore volume of about 0.8 mL/g. In some embodiments, the dry gel zeolite has an average pore volume of about 0.9 mL/g. In some embodiments, the dry gel zeolite has an average pore volume of about 1.0 mL/g. In some embodiments, the dry gel zeolite has an average pore volume of about 1.1 mL/g. In some embodiments, the dry gel zeolite has an average pore volume of about 1.2 mL/g. In some embodiments, the dry gel zeolite has an average pore volume of about 2.5 mL/g. In some embodiments, the dry gel zeolite has an average pore volume of about 5.0 mL/g.

### Examples

### Example 1. Comparison of the Hydrogel Gel Vacuum Drying Method with Conventional Drying Methods

To compare the effect of the disclosed hydrogel drying method on zeolite product properties, one ZSM-5 (Ref. ZSM-5) and one zeolite beta (Ref. Beta) were prepared with conventional oven drying methods, and four zeolites were synthesized using the disclosed hydrogel drying method (Z1, Z2, B1, and B2). The results are summarized below in Table 1. When the conventional oven drying method was used, the synthesis repeatability was poor. For example, in one zeolite beta synthesis, the relative crystallinity was 90%, surface area was 560 m2/g, however, in another repeat synthesis, the relative crystallinity and surface area became 57% and 345 m2/g. With the vacuum drying method, the repeatability is good. Compared to conventional oven drying methods, the disclosed vacuum drying method required less drying time (e.g., from 24 to 30 h for the conventional oven drying method to 6 h). All of the summarized properties are within experimental error.

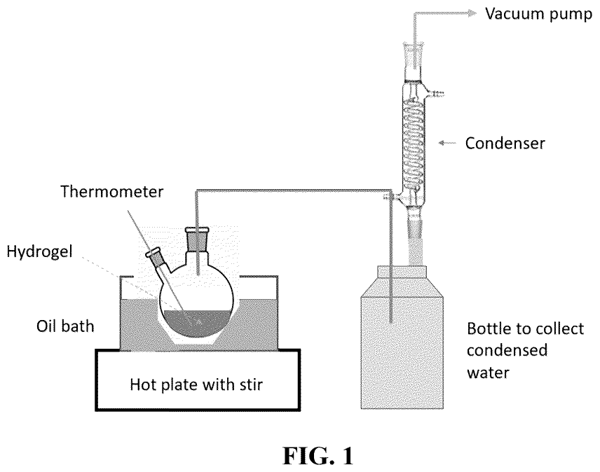

Experiment 1: Synthesis of Reference ZSM-5 with Conventional Oven Drying (Ref. ZSM-5)
1. Al(NO₃)₃·9 H₂O (1.5 g) was dissolved in deionized water (16.38 g). TPAOH (36.6 g) was added to the solution. The resulting solution was mixed for 30 min.
2. Fumed silica (12.02 g) was added to the solution and stirred for 2 h.
3. The solution was stirred and heated to 80° C. until the stir bar could no longer move. The zeolite hydrogel was heated in an oven at 110° C. for 24 h.
4. The dried sample was ground to powder.
5. The dried powder was placed in a TEFL holder in an autoclave with water (10 mL). The autoclave was maintained at 170° C. for 3 d.
6. The solid product was separated and washed with deionized water three times.
7. The solid product was dried at 120° C. for 6 h.
8. The solid product was calcinated at 550° C. for 4 h (ramp rate 2° C./min).
   Experiment 2: Synthesis of Reference Beta with Conventional Oven Drying (Ref. Beta)
1. Al₂(SO₄)₃ (3.15 g) was added to a beaker, combined with aqueous TEAOH solution (31.56 g, 35%), and stirred at room temperature until the Al₂(SO₄)₃ dissolved to form a clear solution.
2. Fumed silica (7.5 g) was added to the solution to form slurry. The slurry was mixed at room temperature for 4 h.
3. The mixture was stirred and heated to 80° C., removing the water, until the stir bar could no longer move.
4. The solid was dried in an oven at 80° C. for 30 h.
5. The solid was ground to fine powder.
6. The solid powder was added into an autoclave with about 10 ml of water added to the bottom of the autoclave. The autoclave was maintained at 140° C. for 3 d.
7. The solid product was washed three times with deionized water.
8. The solid product from was dried in an oven at 110° C. overnight.
9. The solid product was calcinated at 550° C. for 4 h (ramp rate 2° C./min).
Experiment 3: Synthesis of Zeolite ZSM-5 Example 1 with Vacuum Drying Method (Z1)
1. Al(NO₃)₃·9 H₂O (1.5 g) was dissolved in deionized water (16.38 g). TPAOH (36.6 g) was added to the solution. The resulting solution was mixed for 30 min.
2. Fumed silica (12.02 g) was added to the solution and stirred for 2 h to form a zeolite hydrogel.
3. The zeolite hydrogel was added into the 2-neck flask which was part of the hydrogel drying device shown in FIG. 1 and heated to 60° C. under 0.01 mbar pressure for 6 h, forming a dry gel zeolite.
4. The dry gel zeolite was ground to powder.
5. The dried powder was placed in a TEFL holder in an autoclave with water (10 mL). The autoclave was maintained at 170° C. for 3 d.
6. The solid product was separated and washed with deionized water three times.
7. The solid product was dried at 120° C. for 6 h.
8. The solid product was calcinated at 550° C. for 4 h (ramp rate 2° C./min).
   Experiment 4: Synthesis of Zeolite ZSM-5 Example 2 with Vacuum Drying Method (Z2) Zeolite Z2 was prepared by repeating Experiment 3, the preparation of zeolite Z1.
   Experiment 5: Synthesis of Zeolite Beta Example 1 with Vacuum Drying Method (B1)
1. Al₂(SO₄)₃ (3.15 g) was added to a beaker, combined with aqueous TEAOH solution (31.56 g, 35%), and stirred at room temperature until the Al₂(SO₄)₃ dissolved to form a clear solution.
2. Fumed silica (7.5 g) was added to the solution to form slurry. The slurry was mixed at room temperature for 4 h.
3. The zeolite hydrogel was added into the 2-neck flask which was part of the hydrogel drying device shown in FIG. 1 and heated to 60° C. under 0.01 mbar pressure for 6 h, forming a dry gel zeolite.
4. The solid was ground to fine powder.
5. The solid powder was added into an autoclave with about 10 mL of water added to the bottom of the autoclave. The autoclave was maintained at 140° C. for 3 d.
6. The solid product was washed three times.
7. The solid product from was dried in an oven at 110° C. overnight.
8. The solid product was calcinated at 550° C. for 4 h (ramp rate 2° C./min).
   Experiment 6: Synthesis of Zeolite Beta Example 2 with Vacuum Drying Method (B2)

Zeolite B2 was prepared by repeating Experiment 5, the preparation of zeolite B1.

TABLE 1
Main properties of two reference zeolites and 4 invented zeolites

| | Ref. | | | Ref. | | |
|---|---|---|---|---|---|---|
| | ZSM-5^{a} | Z1 | Z2 | Beta^{a} | B1 | B2 |
| Experiment No. | 1 | 3 | 4 | 2 | 5 | 6 |

Synthesis Conditions

| | | | | | | |
|---|---|---|---|---|---|---|
| Crystallization | 170 | 170 | 170 | 140 | 140 | 140 |
| Temperature (° C.) | | | | | | |
| Crystallization Time (d) | 3 | 3 | 3 | 3 | 3 | 3 |

Zeolite Properties

| | | | | | | |
|---|---|---|---|---|---|---|
| Particle Size (nm)^{b} | 80 | 80 | 80 | 50 | 50 | 50 |
| Crystallinity (%) | 70 | 90 | 91 | 88 | 93 | 95 |
| Repeatability | Poor | Good | Good | Poor | Good | Good |
| Surface Area (m²/g)^{c} | 419 | 420 | 425 | 551 | 580 | 590 |
| Pore Volume (mL/g) | 0.90 | 0.91 | 0.92 | 1.04 | 1.10 | 1.20 |
| Average Pore Size (nm) | 8.6 | 8.7 | 8.7 | 7.6 | 7.6 | 8.1 |

^{a} Data presented in these columns is the average based on multiple syntheses
^{b} As measured by SEM
^{c}Brunauer-Emmett-Teller surface area

As shown in Table 1, the vacuum drying method used for experiments Z1, Z2, B1, and B2 resulted in higher crystallinities and repeatability compared to conventional drying methods (Ref. ZSM-5 and Ref. Beta). The dry gel zeolites obtained from Z1, Z2, B1, and B2 demonstrated comparable particle size, surface area, pore volume, and average pore size to those obtained from conventional drying methods (Ref. ZSM-5 and Ref. Beta).

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Embodiments

Embodiment 1. A method of preparing a dry gel zeolite comprising:
combining zeolite precursor materials;
stirring the zeolite precursor materials to form a zeolite hydrogel; and
drying the zeolite hydrogel at a pressure of about 0.001 mbar to about 250 mbar and a temperature of about 20° C. to about 100° C. to form the dry gel zeolite.

Embodiment 2. The method of embodiment 1, wherein the method further comprises:
grinding the dry gel zeolite.

Embodiment 3. The method of embodiment 1 or 2, wherein the method further comprises:
crystallizing the dry gel zeolite.

Embodiment 4. The method of any one of embodiments 1-3, wherein the method further comprises:
isolating the dry gel zeolite.

Embodiment 5. The method of any one of embodiments 1-4, wherein the method further comprises:
washing the dry gel zeolite with a solvent.

Embodiment 6. The method of any one of embodiments 1-5, wherein the method further comprises:
heating the dry gel zeolite.

Embodiment 7. The method of any one of embodiments 1-6, wherein the method further comprises:
calcinating the dry gel zeolite.

Embodiment 8. A method of preparing a dry gel zeolite comprising:
combining zeolite precursor materials;
stirring the zeolite precursor materials to form a zeolite hydrogel;
drying the zeolite hydrogel at a pressure of about 0.001 mbar to about 250 mbar and a temperature of about 20° C. to about 100° C. to form the dry gel zeolite;
grinding the dry gel zeolite;
crystallizing the dry gel zeolite;
isolating the dry gel zeolite;
washing the dry gel zeolite;
heating the dry gel zeolite; and
calcinating the dry gel zeolite.

Embodiment 9. The method of any one of embodiments 1-8, wherein the zeolite precursor materials comprise an aluminum source, a silica source, and a template source.

Embodiment 10. The method of embodiment 9, wherein the aluminum source is selected from NaAlO₂, aluminum isopropoxide (AIP), Al₂(SO₄)₃, Al(NO₃)₃, AlCl₃, aluminum powder, Al(OH)₃, and Al₂O₃.

Embodiment 11. The method of embodiment 9, wherein the silicon source is selected from tetraethylorthosilicate (TEOS), colloidal silica, Na₂SiO₃, and fumed silica.

Embodiment 12. The method of embodiment 9, wherein the template source is selected from tetrapropylammonium hydroxide (TPAOH) and tetraethylammonium hydroxide (TEAOH).

Embodiment 13. The method of embodiment 9, wherein:
the aluminum source is selected from NaAlO₂, aluminum isopropoxide (AIP), Al₂(SO₄)₃, Al(NO₃)₃, AlCl₃, aluminum powder, Al(OH)₃, and Al₂O₃;
the silica source is selected from tetraethylorthosilicate (TEOS), colloidal silica, Na₂SiO₃, and fumed silica; and
the template source is selected from tetrapropylammonium hydroxide (TPAOH) and tetraethylammonium hydroxide (TEAOH).

Embodiment 14. The method of any one of embodiments 1-13, wherein the dry gel zeolite is ZSM-5 or zeolite beta.

Embodiment 15. The method of any one of embodiments 1-14, wherein drying the zeolite hydrogel is performed at a pressure of about 0.005 mbar to about 15 mbar.

Embodiment 16. The method of any one of embodiments 1-14, wherein drying the zeolite hydrogel is performed at a pressure of about 0.01 mbar to about 10 mbar.

Embodiment 17. The method of any one of embodiments 1-17, wherein drying the zeolite hydrogel is performed at a temperature of about 30° C. to about 90° C.

Embodiment 18. The method of any one of embodiments 1-17, wherein drying the zeolite hydrogel is performed at a temperature of about 40° C. to about 80° C.

Embodiment 19. The method of any one of embodiments 1-17, wherein drying the zeolite hydrogel is performed at a temperature of about 60° C.

Embodiment 20. The method of any one of embodiments 1-19, wherein drying the zeolite hydrogel is performed for about 12 h or less.

Embodiment 21. The method of any one of embodiments 1-19, wherein drying the zeolite hydrogel is performed for about 2 h to about 10 h.

Embodiment 22. The method of any one of embodiments 1-19, wherein drying the zeolite hydrogel is performed for about 4 h to about 8 h.

Embodiment 23. The method of any one of embodiments 1-14, wherein drying the zeolite hydrogel is performed at a pressure of about 0.005 mbar to about 15 mbar, a temperature of about 30° C. to about 90° C. for about 2 h to about 10 h.

Embodiment 24. The method of any one of embodiments 1-14, wherein drying the zeolite hydrogel is performed at a pressure of about 0.01 mbar to about 10 mbar, a temperature of about 40° C. to about 80° C. for about 4 h to about 8 h.

Embodiment 25. The method of any one of embodiments 8-24, wherein crystallizing the dry gel zeolite is performed in an autoclave.

Embodiment 26. The method of any one of embodiments 8-25, wherein crystallizing the dry gel zeolite is performed at a temperature of about 100° C. to about 250° C. for about 12 h to about 5 d.

Embodiment 27. The method of any one of embodiments 8-26, wherein heating the dry gel zeolite comprises heating the dry gel zeolite to a temperature of about 80° C. to about 150° C. for about 6 h to about 36 h.

Embodiment 28. The method of any one of embodiments 8-27, wherein calcinating the dry gel zeolite comprises heating the dry gel zeolite to a temperature of about 450° C. to about 650° C. for about 1 h to about 8 h.

Embodiment 29. The method of any one of embodiments 1-28, wherein the dry gel zeolite has a relative crystallinity of 90% or greater.

Embodiment 30. The method of any one of embodiments 1-29, wherein drying the zeolite hydrogel takes less time than a method of preparing a dry gel zeolite wherein drying the zeolite hydrogel is not performed at a pressure of about 0.001 mbar to about 25 mbar and a temperature of about 20° C. to about 100° C. to form the dry gel zeolite.

Embodiment 31. The method of any one of embodiments 9-30, wherein the method uses about 80% less template source than a method of preparing a dry gel zeolite wherein drying the zeolite hydrogel is not performed at a pressure of about 0.001 mbar to about 25 mbar and a temperature of about 20° C. to about 100° C. to form the dry gel zeolite.

What is claimed is:

1. A method of preparing a dry gel zeolite comprising:
combining zeolite precursor materials;
stirring the zeolite precursor materials to form a zeolite hydrogel; and
drying the zeolite hydrogel at a pressure of about 0.001 mbar to about 250 mbar and a temperature of about 20° C. to about 100° C. to form the dry gel zeolite.

2. The method of claim 1, wherein the method further comprises:
crystallizing the dry gel zeolite.

3. The method of claim 1, wherein the method further comprises:
heating the dry gel zeolite.

4. The method of claim 1, wherein the method further comprises:
calcinating the dry gel zeolite.

5. The method of claim 1, wherein the zeolite precursor materials comprise an aluminum source, a silica source, and a template source.

6. The method of claim 5, wherein the aluminum source is selected from NaAlO₂, aluminum isopropoxide (AIP), Al₂(SO₄)₃, Al(NO₃)₃, AlCl₃, aluminum powder, Al(OH)₃, and Al₂O₃.

7. The method of claim 5, wherein the silicon source is selected from tetraethylorthosilicate (TEOS), colloidal silica, Na₂SiO₃, and fumed silica.

8. The method of claim 5, wherein the template source is selected from tetrapropylammonium hydroxide (TPAOH) and tetraethylammonium hydroxide (TEAOH).

9. The method of claim 5, wherein:
the aluminum source is selected from NaAlO₂, aluminum isopropoxide (AIP), Al₂(SO₄)₃, Al(NO₃)₃, AlCl₃, aluminum powder, Al(OH)₃, and Al₂O₃;
the silica source is selected from tetraethylorthosilicate (TEOS), colloidal silica, Na₂SiO₃, and fumed silica; and
the template source is selected from tetrapropylammonium hydroxide (TPAOH) and tetraethylammonium hydroxide (TEAOH).

10. The method of claim 1, wherein the dry gel zeolite is ZSM-5 or zeolite beta.

11. The method of claim 1, wherein drying the zeolite hydrogel is performed at a pressure of about 0.005 mbar to about 15 mbar.

12. The method of claim 1, wherein drying the zeolite hydrogel is performed at a temperature of about 40° C. to about 80° C.

13. The method of claim 1, wherein drying the zeolite hydrogel is performed for about 2 h to about 10 h.

14. The method of claim 1, wherein drying the zeolite hydrogel is performed for about 4 h to about 8 h.

15. The method of claim 1, wherein drying the zeolite hydrogel is performed at a pressure of about 0.005 mbar to about 15 mbar, a temperature of about 30° C. to about 90° C. for about 2 h to about 10 h.

16. The method of claim 1, wherein drying the zeolite hydrogel is performed at a pressure of about 0.01 mbar to about 10 mbar, a temperature of about 40° C. to about 80° C. for about 4 h to about 8 h.

17. The method of claim 1, wherein the dry gel zeolite has a relative crystallinity of 90% or greater.

18. The method of claim 1, wherein drying the zeolite hydrogel takes less time than a method of preparing a dry gel zeolite wherein drying the zeolite hydrogel is not performed at a pressure of about 0.001 mbar to about 25 mbar and a temperature of about 20° C. to about 100° C. to form the dry gel zeolite.

19. The method of claim 1, wherein the method uses less template source than a method of preparing a dry gel zeolite wherein drying the zeolite hydrogel is not performed at a pressure of about 0.001 mbar to about 25 mbar and a temperature of about 20° C. to about 100° C. to form the dry gel zeolite.

20. A method of preparing a dry gel zeolite comprising:
combining zeolite precursor materials;
stirring the zeolite precursor materials to form a zeolite hydrogel;
drying the zeolite hydrogel at a pressure of about 0.001 mbar to about 250 mbar and a temperature of about 20° C. to about 100° C. to form the dry gel zeolite;
grinding the dry gel zeolite;
crystallizing the dry gel zeolite;
isolating the dry gel zeolite;
washing the dry gel zeolite;
heating the dry gel zeolite; and
calcinating the dry gel zeolite.
